(19) United States
(12) Patent Application Publication
(10) Pub. No.: US 2006/0069746 A1
(43) Pub. Date: Mar. 30, 2006

(54) System and method for smart persistent cache

(76) Inventors: Franklin A. Davis, Newton, MA (US); William D. Beaty, Lewisville, TX (US)

Correspondence Address: Hollingsworth & Funk, LLC;Suite 125, 8009 34th Avenue South, Minneapolis, MN, 55425, US

(21) Appl. No.: 10/936,777

(22) Filed: Sep. 8, 2004

(51) Int. Cl. G06F 15/16

(52) U.S. Cl. 709/218

(57) ABSTRACT

A system and method for smart, persistent cache management of received content within a terminal. Received content is tagged with cache directive allowing cache control to determine which of cache storage locations to use for storage of content. Cache control detects the number of instances that received content correlates to a newer version of purged content and provides the ability to re-classify cache persistence directive based upon the number of instances.

### FIELD OF THE INVENTION

This invention relates in general to content storage control, and more particularly, to smart content storage control based upon cache directives associated with the content or automatic detection that content is important.

### BACKGROUND OF THE INVENTION

The mobile industry has experienced a period of exceptional growth during the past several years, where mobile voice and simple Short Message Service (SMS) text messaging have provided the primary drivers for this growth. The next wave of growth is expected to come from new mobile services where content, not just voice, will be mobilized. To insure a successful launch of these new mobile services, service enablers are used to create the mobile services according to at least the following criteria: enablement of new and better services for consumers; provision of facilities to developers to speed up the development of the mobile services; and insuring interoperability through the use of open global standards.

The use of open global standards, such as those endorsed by the Open Mobile Alliance (OMA), minimizes fragmentation of the service enablers and insures seamless interoperability between different vendors. Some of the key service enablers used for the successful take-up of the mobile services include: Multimedia Messaging Service (MMS); Mobile Digital Rights Management (MDRM); and mobile browsing, to name only a few.

The essence of mobile browsing lies in its close alignment with widely accepted Internet standards. The Wireless Application Protocol (WAP) Forum and the World Wide Web Consortium (W3C) have successfully defined mobile Internet standards over the past several years. Just recently, the WAP Forum has adopted the Extensible HyperText Markup Language (XHTML) Basic standard from the W3C as the basis for the latest revision of WAP. Even more recently, additions to XHTML Basic from full XHTML 1.0 plus some mobile style tags, have yielded XHTML Mobile Profile (MP), thus strengthening the position of the mobile browser in the mainstream Internet to allow for a far greater range of presentation and formatting than previously possible. According to the OMA specification, XHTML MP defines a document type that is rich enough to be used for content authoring and precise document layout, yet can be shared across different classes of devices, such as desktop computers, Personal Digital Assistants (PDA), TV, mobile devices, etc.

As the user interacts within a particular browsing session, a browser is used to view Web pages, and their associated image content and Cascading Style Sheets (CSS), defined by their associated Uniform Resource Locators (URLs). Often, a user wishes to visit previously visited URLs, such as those URLs that the user has pre-defined as being among his favorite URLs. Additionally, the service provider or a user is able to define a default URL, e.g., home Web page, such that instantiation of the browser causes the content of the home Web page to be displayed at the beginning of his browsing session. Additionally, the default Web page allows the user to easily return home to begin another browsing activity.

In order to accelerate a browsing session, Web page caching is used by the browser to facilitate reuse of recently visited Web pages, along with their corresponding images and CSS files, by temporarily storing them within a local memory called a cache, so long as they meet other caching criteria, e.g., no cache prohibiting headers are present and the Expiration time of the Web page has not been exceeded. Certain Web pages are always needed, such as a home Web page or other Web pages that are frequently visited by the user. Once the cached Web pages are selected by the user, their content is retrieved from the cache, as opposed to being accessed from the origin server (also known as a “Web server” or “hosting server”) defined by the corresponding URL. In such an instance, the time required to render the content contained within the Web page has been significantly reduced because the need to traverse the network to access the content from the origin server has been obviated by making the content locally available within the cache.

The storage capacity of the Web page cache is limited, however, especially when the cache exists within a mobile terminal. Algorithms are required, therefore, to manage the Web page cache in order to prevent overflow. One such cache management algorithm utilizes metrics of the visited URLs in order to manage the content of the Web page cache. In particular, the cache management algorithm evaluates the access time stamp for each URL visited, such that the Most Recently Used (MRU) URLs are, for example, stored within the top of the cache, whereas the Least Recently Used (LRU) URLs get pushed down to the bottom of the cache. Accordingly, once the cache is full, newly cached URLs entering the top of the cache tend to push the LRU URLs out of the bottom of the cache, purging their data (Web page, image, or CSS file) from the cache. Thus, if the user wishes to re-visit a LRU URL that has been purged from the cache, that URL must be accessed through its corresponding origin server by traversing the network.

Additionally, the “Expires” header that may be sent by the network for each visited URL, indicates a date/time that the document is set to expire, whereby any “Expires” header having a time that is earlier than the current time becomes invalid. When the Expires time for any URL in the cache has passed, the document is purged from the cache, even if it is not on the bottom of the LRU stack. This may free space for newly cached URLs to enter the top of the cache without having to purge LRU URLs. When the user re-visits a URL that was purged from the cache, the browser must then fetch a new version of the document by traversing the network.

The user's home page may be the most important Web page stored within the cache. However, the user's home page often falls victim to the prior art LRU algorithm, since the user's home page is normally the starting place for the browsing session and is often the oldest URL present in the cache once it becomes full. Accordingly, through operation of the prior art LRU algorithm, the user's home page is continually being re-loaded Over The Air (OTA), in the case that the user is operating with a mobile browser, which can be time consuming, especially if the home page contains many graphical images.

One prior art attempt to mitigate the effects of the LRU algorithm, is to allow the user to save favorite Web pages, which enables their markup content to be accessible while the browsing terminal is off line, i.e., not actively connected to the network. This save process allows a copy of the Web page to be stored in persistent storage, which allows the stored copy of the Web page to be synchronized to its corresponding network version. This prior art method, however, does not automatically update the Web page when it is due to expire, nor does it enable the origin server to push an updated version of the Web page to the browsing terminal.

Accordingly, there is a need in the communications industry for a system and method that provides a purge prevention mechanism, whereby particular Web pages within the cache are not purged by the prior art LRU algorithm. Additionally, there is a need to prevent the purging of images, CSS, and other files that may be included with the cached Web page. Still further, the purge protected Web pages and associated files should allow updating when, for example, their corresponding network content changes or the date/time in their Expires header has passed.

### SUMMARY OF THE INVENTION

To overcome limitations in the prior art, and to overcome other limitations that will become apparent upon reading and understanding the present specification, the present invention discloses a system and method that allows locks to be associated with cached Web pages so that they are not automatically purged by a cache management algorithm. Additionally, the images, CSS, and other files that may be included in the locked Web page may also be locked to prevent inadvertent purging of their content. Still further, the locked Web pages and associated locked files allow updating when, for example, their corresponding network content changes.

In accordance with one embodiment of the invention, a network browsing system is provided. The network browsing system comprises a network having Web pages addressable by Uniform Resource Locators (URLs), and a terminal coupled to the network to receive content associated with the Web pages. The terminal includes a cache controller adapted to determine cache attributes of the received content, and a cache memory coupled to the cache controller to store the content in a location indicated by the cache attributes.

In accordance with another embodiment of the invention, a method for managing content received by a terminal from a network is provided. The method comprises inspecting a priority directive associated with the received content, allowing a modification to be made on the priority directive of the received content, and storing the received content in a storage location indicative of the priority directive.

In accordance with another embodiment of the invention, an origin server coupled to a network to provide priority directives within requested content hosted by the origin server is provided. The origin server comprises means for receiving a content request from a browsing terminal, means for generating content in response to the content requests, means for adding priority directives to header information associated with the requested content, and means for sending a response to the browsing terminal containing the header information and requested content. The priority directives are indicative of a storage location to be used for the requested content.

In more particular embodiments according to the present invention, the priority directives indicate the relative importance of the content, and may be used by the browsing terminal to determine a storage location or other means of caching the document and its included CSS, images and other files.

In accordance with another embodiment of the invention, a computer-readable medium having instructions stored thereon which are executable by an origin server is provided. The instructions perform steps comprising receiving a content request from a browsing terminal, generating content in response to the content requests, and adding priority directives to header information associated with the requested content.

In a more particular embodiment according to the present invention, the priority directives indicate the relative importance of the content, which may then be used by the browsing terminal's cache manager to determine a storage location or other means of caching the content and its included CSS, images and other files.

In accordance with another embodiment of the invention, a mobile terminal capable of being wirelessly coupled to a network to receive content hosted by a content provider within the network is provided. The mobile terminal comprises a memory capable of storing at least one of a cache control module and a cache memory module, a processor coupled to the memory and configured by the cache control module to direct the received content into portions of the cache memory module, and a transceiver configured to facilitate the content exchange. The cache control module is responsive to cache and priority directives supplied by the content provider in determining which portion of the cache memory module to use for storage.

In accordance with another embodiment of the invention, a computer-readable medium having instructions stored thereon which are executable by a mobile terminal for providing a smart persistent cache is provided. The instructions perform steps comprising storing received content into one of a persistent cache storage location and a normal cache storage location in response to a priority directive associated with the received content, conditionally purging content from the persistent cache storage location to provide storage for high priority received content, the high priority received content having a priority directive indicative of the persistent cache storage location, and diverting the high priority received content to the normal cache storage location when purging content from the persistent cache storage location is not allowed.

In more particular embodiments according to the present invention, lower priority content is purged from the persistent cache storage location when the cache is full. If no lower-priority content is present within the persistent cache storage location, then the least-recently-used content having the same priority as the received content is purged. Under no circumstances will the received content cause purging of higher-priority content from the persistent cache storage location. All content that is purged from the persistent cache storage location is diverted to the normal cache.

In accordance with another embodiment of the invention, a method of determining a storage location for received content is provided. The method comprises comparing the received content to previously purged content, incrementing a purge count if the received content matches a Uniform Resource Locator (URL) of the previously purged content, comparing the purge count to a predetermined threshold, automatically assigning a priority directive and allowing storage of the received content into a persistent cache if the purge count exceeds the predetermined threshold, and storing the received content into normal cache if the purge count does not exceed the predetermined threshold.

In accordance with another embodiment of the invention, a method of automatically determining a priority directive of received content comprises detecting an absence of a priority directive within the received content, comparing a Uniform Resource Locator (URL) associated with the received content to a previously stored service provider's URL directory tree, and assigning a priority directive to the received content in response to finding a match between the URL associated with the received content and the previously stored service provider's URL directory tree. The assigned priority directive is indicative of a position of the matched URL in the service provider's URL directory tree.

In accordance with another embodiment of the invention, a method of automatically determining a priority directive of received content comprises comparing a Uniform Resource Locator (URL) associated with the received content to a list of frequently accessed URLs, and assigning a priority directive to the received content in response to finding a match between the URL associated with the received content and the list of frequently accessed URLs. The assigned priority directive is indicative of a frequency of use of the matched URL.

These and various other advantages and features of novelty which characterize the invention are pointed out with greater particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, apparatus, and method in accordance with the invention.

### BRIEF DESCRIPTION OF THE DRAWINGS

The invention is described in connection with the embodiments illustrated in the following diagrams.

FIG. 1 illustrates an exemplary communication system in which the principles of the present invention may be utilized;

FIG. 2 illustrates an exemplary message format in accordance with the present invention;

FIG. 3 illustrates an exemplary message flow diagram in accordance with the present invention;

FIG. 4 illustrates an alternate message flow diagram according to the present invention;

FIG. 5 illustrates a cache maintenance procedure in accordance with the present invention;

FIG. 6 illustrates a smart persistent algorithm in accordance with the present invention;

FIG. 7 illustrates an exemplary flow diagram in accordance with the present invention;

FIG. 8 illustrates a representative mobile computing arrangement suitable for providing cache management in accordance with the present invention; and

FIG. 9 is a representative computing system capable of carrying out origin server functions according to the present invention.

### DETAILED DESCRIPTION OF THE INVENTION

In the following description of the exemplary embodiment, reference is made to the accompanying drawings that form a part hereof, and in which is shown by way of illustration various embodiments in which the invention may be practiced. It is to be understood that other embodiments may be utilized, as structural and operational changes may be made without departing from the scope of the present invention.

Generally, the present invention is directed to a system and method of smart, persistent cache within a browsing terminal to contain important content separately from the normal cache. The present invention allows accelerated browsing sessions by using two cache storage locations: a persistent cache, used for content identified as being important; and the normal cache, which may or may not store content persistently after the browser application is exited or the mobile terminal is powered off. Persistent storage locations may be directed for use by the content provider by applying the appropriate priority directive within a header portion of the content provided. The value of the priority directive determines which higher-priority content should remain in the persistent cache when the cache is full and new content is received that has a lower priority. Lower priority content that does not fit in the persistent cache is diverted to the normal cache. The browser terminal may automatically determine that the service provider's home page and related pages are to be stored in the persistent cache even if the origin server does not send priority directives with the content. The user of the browsing terminal may override the priority directive applied by content providers other than the service provider to prohibit invasive content providers. The need for persistent storage may be automatically detected when discarded content frequently matches content being received. Content providers may also force regular updates of persistent storage within the browsing terminals by using a cache expiration directive to age the content in either the normal cache or the persistent cache to a stale state, thus forcing an update to occur.

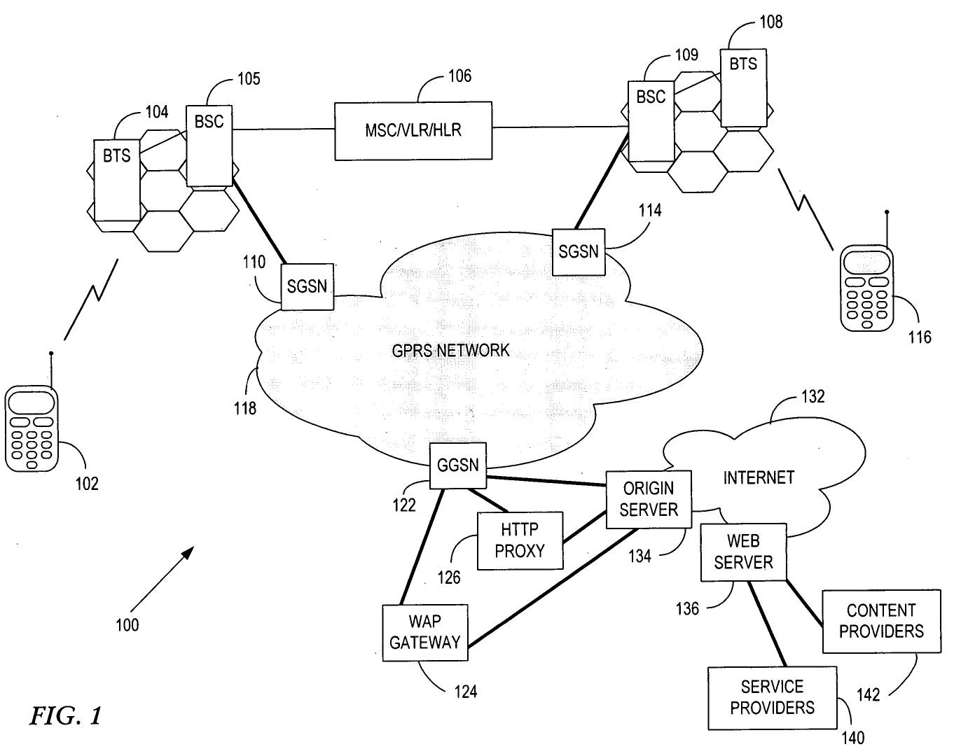

FIG. 1 illustrates exemplary communication system 100 in which the principles of the present invention may be utilized. Communication system 100 utilizes General Packet Radio Service (GPRS) network 118 as the communications backbone. GPRS is a packet-switched service for the Global System for Mobile Communications (GSM) that mirrors the Internet model and enables seamless transition towards 3G (third generation) networks. GPRS thus provides actual packet radio access for mobile GSM and time-division multiple access (TDMA) users, and is ideal for Wireless Application Protocol (WAP) services. While the exemplary embodiments of FIG. 1 are generally described in connection with GPRS/GSM, it should be recognized that the specific references to GSM and GPRS are provided to facilitate an understanding of the invention. As will be readily apparent to those skilled in the art from the description provided herein, the invention is equally applicable to other technologies, including other circuit-switched and packet-switched technologies, 3G technologies, and beyond.

Referring to FIG. 1, mobile terminals 102 and 116 communicate with Base Transceiver Station (BTS) 104 and 108, respectively, via an air interface. BTS 104 and 108 are components of the wireless network access infrastructure that terminates the air interface over which subscriber traffic is communicated to and from mobile terminals 102 and 116. Base Station Controller (BSC) 105 and 109 are switching modules that provide, among other things, handoff functions, and power level control in each BTS 104 and 108, respectively. BSC 105 and 109 controls the interface between a Mobile Switching Center (MSC) 106 and BTS 104 and 108, and thus controls one or more BTSs in the call set-up functions, signaling, and use of radio channels. BSC 105 and 109 also controls the respective interfaces between Serving GPRS Support Node (SGSN) 110 and BTS 104 and SGSN 114 and BTS 108.

SGSN 110 serves a GPRS mobile terminal by sending or receiving packets via a Base Station Subsystem (BSS), and more particularly via BSC 105 and 109 in the context of GSM systems. SGSN 110 and 114 are responsible for the delivery of data packets to and from mobile terminals 102 and 116, respectively, within the service area, and they perform packet routing and transfer, mobility management, logical link management, authentication, charging functions, etc. In the exemplary GPRS embodiment shown in FIG. 1, the location register of SGSN 110 stores location information such as the current cell and Visiting Location Register (VLR) associated with mobile terminal 102, as well as user profiles such as the International Mobile Subscriber Identity Number (IMSI) of all GPRS users registered with SGSN 110. SGSN 114 performs similar functions relating to mobile terminal 116. While GSM forms the underlying technology, SGSN 110 and 114 described above are network elements introduced through GPRS technology. Another network element introduced in the GPRS context is the Gateway GPRS Support Node (GGSN) 122, which acts as a gateway between the GPRS network 118 and WAP gateway 124.

Server 134 acts as the operator's origin server, which is used to host the operator's portal or home page. Other content, such as that provided by service providers 140 and content providers 142, is hosted by Web server 136. Access to Internet 132 may be accomplished in any number of ways: directly from GGSN 122; via HTTP proxy 126; or through WAP gateway 124. Access through GGSN 122 or HTTP proxy 126, for example, may be achieved through the use of Transfer Control Protocol/Internet Protocol (TCP/IP) enabled terminals.

WAP enhances the functionality of mobile terminals through real-time interactive services. The protocol has been specifically designed for small screens and low bandwidths, and it offers a wide variety of wireless services over the Internet for mobile devices. It was also designed to allow content to be delivered over any bearer service, even when delivery of the services is enabled over GPRS, 3G, or any other type of network. WAP over GPRS opens up new possibilities for application development and there are also some optimizations in GPRS that can be performed by service developers.

Application developers can use the principles of WAP to develop new services or adapt existing Internet applications for use with mobile devices. Applications are written in: Wireless Markup Language (WML); WMLScript (WMLS); XHTML Mobile Profile (XHTML-MP); Wireless Cascading Style Sheets (WCSS); ECMAScript Mobile Profile; and HTML, and are stored on either of origin server 134, Web server 136, or directly on WAP gateway 124. The content stored on origin server 134 is accessible from mobile devices 102 and 116 via GPRS network 118, GGSN 122, and WAP gateway 124, or through HTTP proxy 126, or directly using TCP/IP to origin server 134. It is recommended to use a HyperText Transfer Protocol (HTTP) proxy (not shown) to cache WML content whenever the content is accessed via Internet 132. The HTTP proxy should either be co-located with WAP gateway 124 or proximately located next to WAP gateway 124 in order to minimize the delay in data transfer between the two components.

Mobile devices 102 and 116 access WAP gateway 124 using a GSM data call, GPRS connection, or other mobile data connection, where they supply a user-agent field within a Wireless Session Protocol (WSP) header or HTTP header when fetching content from origin server 134. When using WSP, the WAP gateway 124 then encapsulates the WSP header within an HTTP header prior to sending to origin server 134. The user-agent header is used by origin server 134, for example, to determine the particular browser that is being used by mobile devices 102 and 116, so that context dependent content may be delivered to mobile devices 102 and 116 by origin server 134.

WAP gateway 124 may be characterized as a Push Protocol Gateway (PPG), whereby PPG 124 sends data received from, for example, content provider 142, to one of terminals 102 or 116. The data being pushed by PPG 124 may be updated versions of data that were previously requested by mobile terminal 102 during a particular browsing session, as described below. Alternatively, PPG 124 may effect cache control through the use of Service Load (SL) commands as discussed below. PPG 124 and mobile terminal 102, for example, communicate via the Push OTA protocol, which utilizes either WSP services, i.e., OTA-WSP services, and/or HTTP services, i.e., OTA-HTTP services. OTA-HTTP is designed to run over HTTP and is intended to be used with bearers that support Transmission Control Protocol/Internet Protocol (TCP/IP), such as GPRS network 118 of FIG. 1.

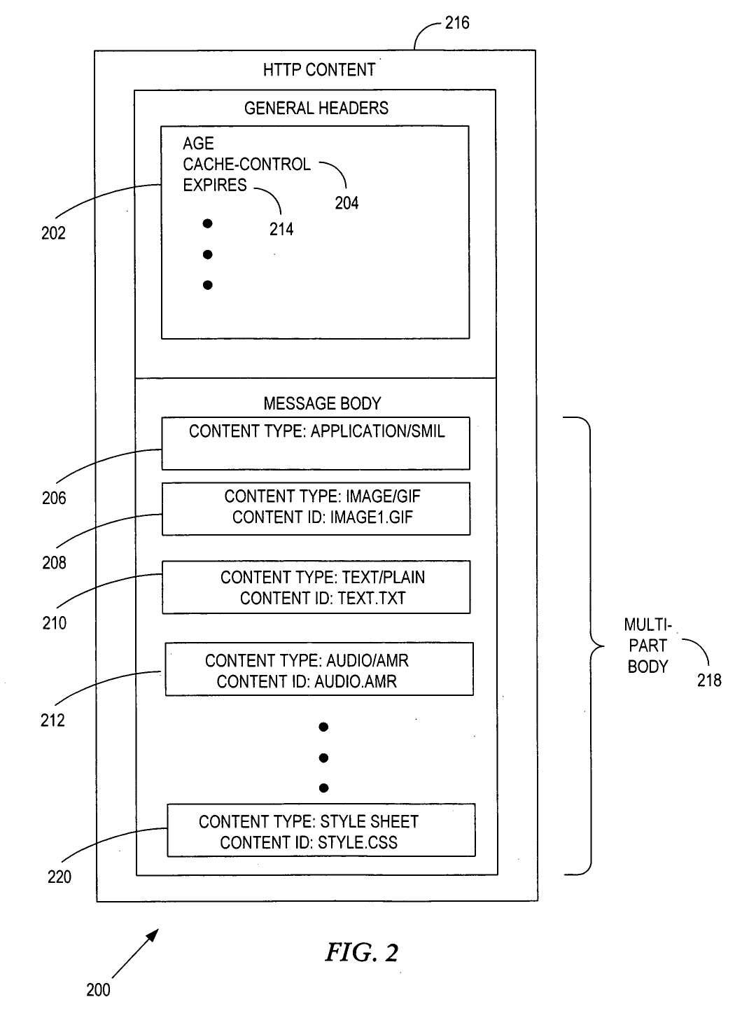

FIG. 2 represents exemplary OTA-HTTP Push message 200 that may be used between mobile terminal 102 and PPG 124 to communicate content previously requested by mobile terminal 102 from content provider 142. Push message 200 may be composed of HTTP content 216 having general header portion 202 and a message body portion composed of either multipart body 218 or of a single MIME type data. The message body may be any Multi-Purpose Internet Mail Extensions (MIME) content type that can be accepted by the browser, including MIME content types 206-212, and 220. For example, message part 206 may indicate a content type of Synchronized Multimedia Integration Language (SMIL) that was generated, for example, from a URL accessed by mobile terminal 102 that further referenced SMIL content. Message part 208 may indicate that a Graphics Interchange Format (GIF) image exists at location “IMAGE1.GIF”, which is followed by message part 210 containing plain text at location “TEXT.TXT”. Message part 212 may provide audio content from an Adaptive Multi-Rate (AMR) codec format at location “AUDIO.AMR”. Finally, message part 220 may contain a style sheet at location “STYLE.CSS”, which may define how message parts 206-210, for example, are to be displayed on the browsing terminal's display.

Cache control may be implemented by any of mobile terminal 102, origin server 134, service providers 140, content providers 142, or PPG 124 through the use of Cache-Control header field 204. Cache-Control header field 204 is used to specify directives that are obeyed by all caching mechanisms along the request/response chain. The directives specify behavior intended to prevent caches from adversely interfering with the request or response and they typically override the default caching algorithms. The cache-control header format that is used within HTTP content 216 is as follows: “Cache-Control” “:” “cache-directive”. Various exemplary cache directives that may be used between mobile terminal 102 and PPG 124 are tabulated in Table 1.

TABLE 1

| Cache-Control Directive | Description |
|---|---|
| no-cache | Field used by the origin server to control |
| | whether the original HTTP content may be |
| | used to service a subsequent request. |
| no-store | Field used by the origin server to prevent |
| | non-volatile storage of HTTP content. |
| max-age | Indicates a maximum allowable age of the |
| | HTTP content. |
| cache-persistent | Field used by the origin server to indicate to |
| | the browsing terminal that the HTTP |
| | content is intended to be persistent. |

If the “Cache-Control” directive is “no-cache”, then a cache, e.g., PPG 124, mobile terminal 102 or 104, should not use the HTTP content to satisfy a subsequent request from mobile terminal 102 without successful revalidation with the origin server, e.g., origin server 134, service providers 140, or content provider 142. This allows origin server 134, service providers 140, or content provider 142 to prevent caching even when it is configured to return stale responses to client requests. The “no-store” directive is used to prohibit the cache from intentionally storing the HTTP content information in non-volatile storage, and to make a best-effort attempt to remove the information from volatile storage as promptly as possible after forwarding it.

The “max-age” directive may be used by origin server 134, service providers 140, content provider 142, or mobile terminal 102 to set a maximum allowable age of HTTP content 216. In the case of content provider 142, for example, the “max-age” directive may be used to set the maximum allowable amount of time that HTTP content 216 is allowed to age without being revalidated by content provider 142. In the case of mobile terminal 102, on the other hand, the “max-age” directive may be used in an HTTP Request to indicate the maximum allowable age of cached content within PPG 124 that is acceptable without first revalidating the content with content provider 142.

An alternative to the use of the “max-age” directive is the use of Expires header 214, which indicates the date/time after which the cached content is considered to be stale. A stale cache entry may not normally be returned by a cache, e.g., either a proxy cache or a user agent cache, unless it is first validated with the origin server, e.g., origin server 134, service providers 140, or content provider 142, or with an intermediate cache that has a fresh copy of the entity.

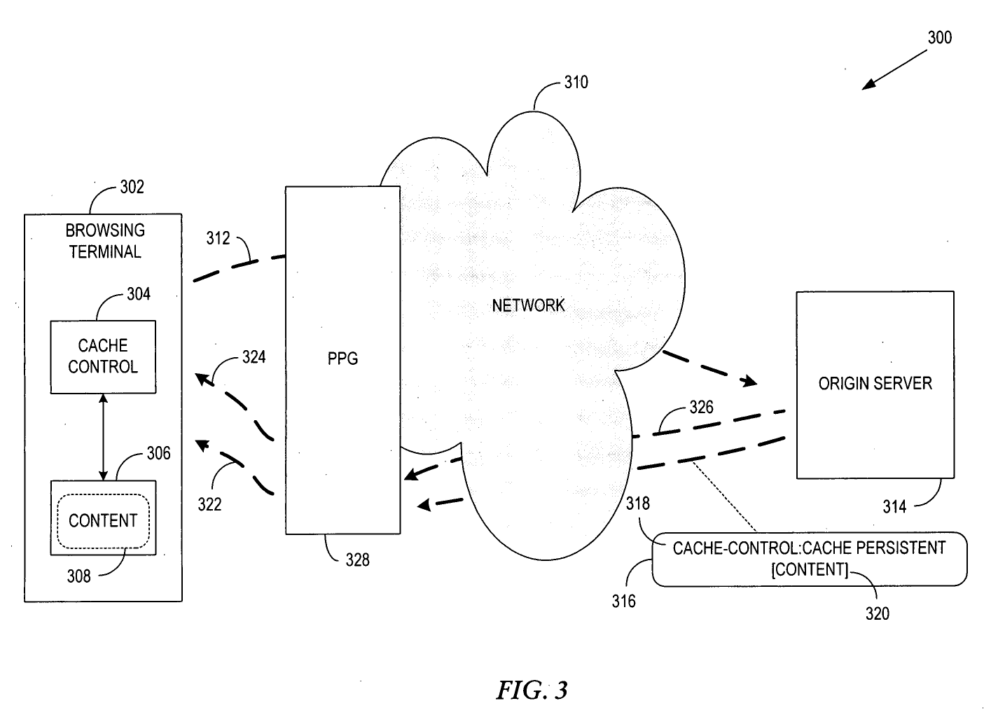

The “cache-persistent” directive is used in accordance with the present invention to indicate to a browsing terminal that the associated HTTP content is to be considered to be persistent, where the persistent content includes the entire multipart body portion 218, or a single MIME type body. The resulting action of the browsing terminal is to place message parts 206-212 and 220 into a persistent memory location, e.g., persistent cache, such that message parts 206-212 and 220 are not purged during the normal cache LRU algorithm implemented by the browsing terminal. The “cache-persistent” directive may be used in several embodiments according to the present invention as illustrated in FIGS. 3-5.

In one embodiment of cache control according to the present invention, message flow diagram 300 of FIG. 3 is used between origin server 314 and browsing terminal 302 to control the cache state of content 308 within browsing terminal 302. During a typical browsing session, for example, browsing terminal 302 requests content contained within origin server 314 via OTA-HTTP Request message 312 via PPG 328 and network 310. In response to the request, origin server 314 provides HTTP Response message 316, which contains the requested content, e.g., content 320, as well as cache control directive 318, e.g., Cache-Control:cache-persistent. HTTP response message 316 is then proxied to browsing terminal 302 via PPG 328 via message 322.

Once message 322 is received by browsing terminal 302, cache control 304 directs content 320 of message 322 to be stored within persistent cache 306 in response to the “cache-persistent” directive contained within OTA-HTTP Response message 322. It should be noted that content 308 may represent the entire linked content of message 316, as exemplified by multipart body 218 of HTTP content 216 of FIG. 2, which includes GIF image defined by message content 208 and the cascading style sheet as defined by message content 220.

It should be noted also, that persistent cache content 308 may obey the expiration rules as defined by the “max-age” directive of Table 1 or Expires header 214 of FIG. 2. In particular, if content 308 ages beyond the time designated by the “max-age” directive or the date/time specified in Expires header 214 has passed, then cache control 304 initiates a refresh command to origin server 314 once the user of mobile terminal 302 requests the URL that corresponds to the location of content 308. Otherwise, if content 308 is still fresh, i.e., content 308 has not aged past the time defined by the “max-age” directive, then a refresh command is not executed by cache control 304, rather content 308 is immediately accessed and displayed to the user of browsing terminal 302 from persistent cache 306.

Expiration rules may also be modified by origin server 314, PPG 328, or other network entities within network 310, through the use of a Service Load (SL) or Cache Operation (CO) command. In such an instance, a Push Initiator (PI), e.g., origin server 314, instructs PPG 328 via message 326 to push an SL or CO to browsing terminal 302 via message 324. Origin server 314 provides the SL or CO with the Universal Resource Identifier (URI) within message 326, which indicates the particular content, e.g., 308, within persistent cache 306 that is of interest.

The CO, for example, causes cache control 304 to invalidate the cached copy of content 308, such that content 308 is made to be stale. Once stale, the updating algorithm within cache control 304 forces a refresh of content 308 the next time that the user of browsing terminal 302 wishes to view content 308. In other words, prior to displaying content 308 to the user, any updates to content 308 are first retrieved from origin server 314 and then applied to content 308. At that time, the age of content 308 is then reset based on the new cache headers. The SL, on the other hand, with action=“cache” causes the browser to request the content from the URL in the background, and process the content in the response to the normal cache rules, while incorporating the method in accordance with the present invention, thus replacing any copy of the content that may already be present in the cache.

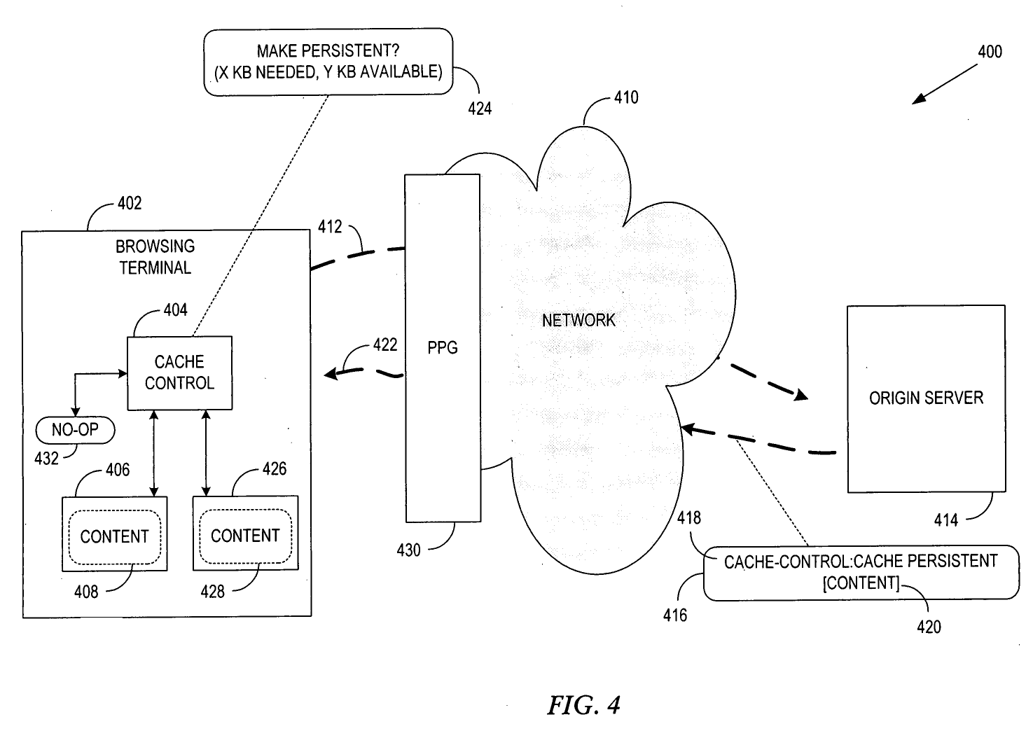

In another embodiment of cache control according to the present invention, message flow diagram 400 of FIG. 4 is used between origin server 414 and browsing terminal 402 to control the cache state of content 408 within browsing terminal 402. During a typical browsing session, for example, browsing terminal 402 requests content contained within origin server 414 via message 412 via PPG 430 and network 410. In response to the request, origin server 414 provides message 416, which contains the requested content, e.g., content 420, as well as cache control directive 418, e.g., Cache-Control:cache-persistent. Response message 416 is then proxied in message 422 to browsing terminal 402 via PPG 430.

Once message 422 is received by browsing terminal 402 and the content 420 has been verified to not exist within persistent cache 406, then cache control 404 displays message 424 to the display of browsing terminal 402. Message 424 indicates to the user of mobile terminal 402 that content marked “cache-persistent” has been received as a result of the browsing session. An opportunity, therefore, is provided by cache control 404 to the user of browsing terminal 402 to override the persistent cache directive sent by origin server 414.

In order to aid the decision to be made by the user, the amount of memory needed to cache content 420 is provided to the user as “X KB NEEDED” within message 424. In addition, the amount of memory available within persistent cache 406 is provided as “Y KB AVAILABLE”. The user may elect to store content 420 within persistent cache 406, in which case cache control 404 directs content 420 of message 422 to be stored within persistent cache 406 as content 408 in response to the user's decision to make content 420 persistent. Otherwise, if the user of browsing terminal 402 does not wish to make content 420 persistent, then cache control 404 directs content 420 to non-persistent cache 426 to be saved as content 428. It should be noted that content 428 is then under the normal LRU cache control algorithm, which will discard content 428 once it is at the bottom of the LRU stack and the cache needs more room to store new content. In this way, the user of browsing terminal 402 may protect against malicious origin servers from locking their respective Web pages within persistent cache 406 of browsing terminal 402 and thereby using up the limited persistent cache storage which might prevent other more important content to be cached persistently.

When the user selects No in response to message 424, the URL of content 428 is added to list NO-OP 432 so that cache control 404 will not ask the user about content 428 again in the future. If NO-OP list 432 becomes full based on a predetermined maximum number of allowed entries, then cache control 404 will store any new content received marked “cache-persistent” into normal LRU non-persistent cache 426. This is to prevent malicious sites from overwhelming the user with “make persistent?” requests, and overrunning the capacity of a mobile terminal to track rejected content.

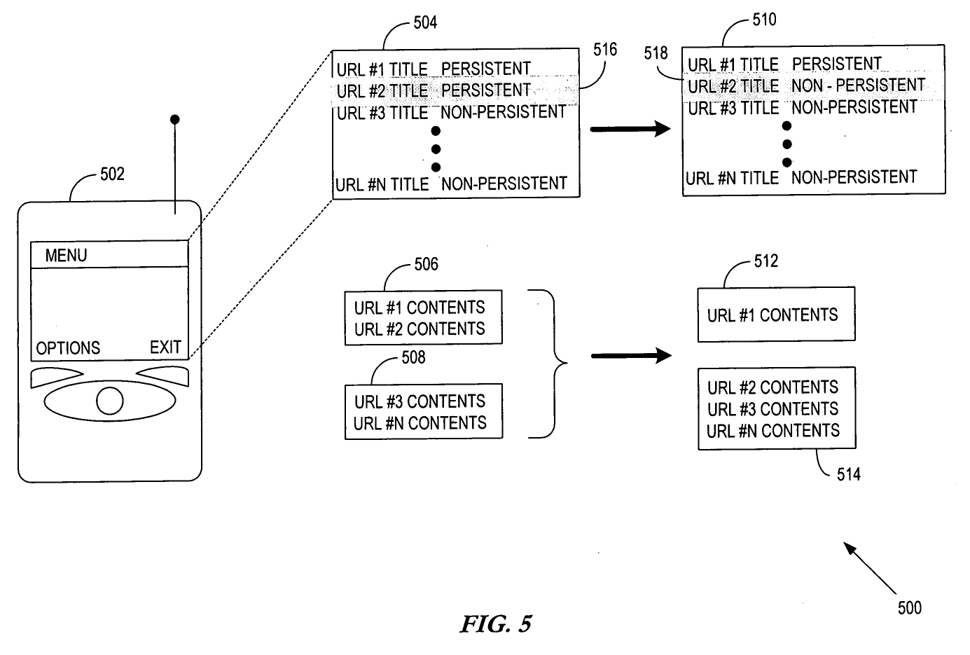

In another embodiment according to the present invention, the user of mobile terminal 502 may have administrative rights to allow maintenance procedure 500 of FIG. 5 to facilitate maintenance of persistent and non-persistent cache as required. In particular, prior to performing maintenance: persistent cache 506 contains URL #1 and URL #2 and their associated contents; and non-persistent cache 508 contains URL #3 to URL #N and their associated contents. Configuration screen 504 allows the user to view the contents of both persistent cache 506 and non-persistent cache 508 indexed by, for example: URL; title; and persistence (i.e., priority) indication as shown. The user may highlight each entry within configuration screen 504 and subsequently select a highlighted entry for edit, e.g., entry 516.

Once activated, the user may toggle the priority indication of entry 516 from persistent to non-persistent as illustrated by edited entry 518 of configuration screen 510. Accordingly, the cache controller (not shown) within mobile terminal 502 transfers the cache entry corresponding to URL #2 from persistent cache 506 to non-persistent cache 514 in response to the priority indication change for URL #2. Thus, persistent cache 512 is reduced in occupancy to containing only a single entry, e.g., URL #1 and associated contents and non-persistent cache 514 is increased in occupancy to containing URL #2-URL #N and their associated contents.

Conversely, configuration screen 504 may also allow the user of mobile terminal 502 to transfer URLs from non-persistent cache to persistent cache. In so doing, the user of mobile terminal 502 may transfer his own frequently used Web pages to persistent cache, thus making his frequently visited Web pages available for faster browsing.

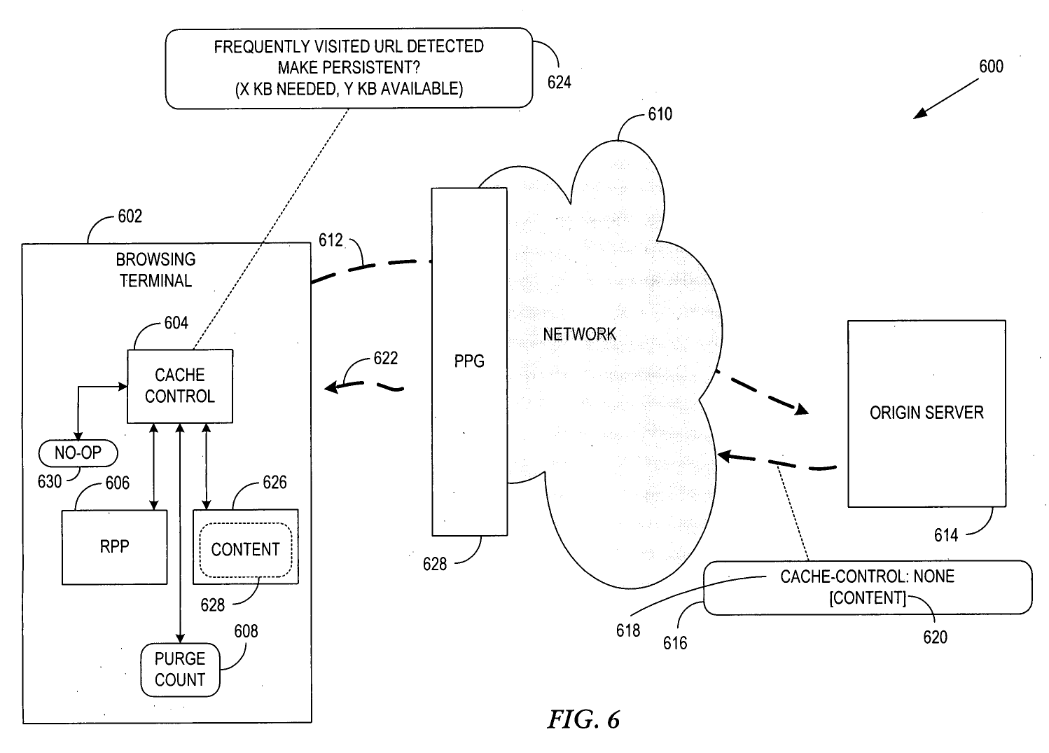

In an alternate embodiment according to the present invention, smart persistence algorithm 600 of FIG. 6 may be implemented by the browser within mobile terminal 602. During a typical browsing session, for example, browsing terminal 602 requests content contained within origin server 614 via message 612 via PPG 628 and network 610. In response to the request, origin server 614 provides message 616, which contains the requested content, e.g., content 620, but with no persistent cache control directive 618. Response message 616 is then proxied to browsing terminal 602 via PPG 628 in message 622.

Once message 622 is received by browsing terminal 602 and the content 620 has been verified to be non-persistent as indicated by the lack of the corresponding cache control directive, then cache control 604 stores content 620 into non-persistent cache 626 as content 628. Once the LRU algorithm imposed upon non-persistent cache 626 determines that content is the least recently used item in the non-persistent cache, then when the cache needs to free some space for new content, content 628 is purged and the URL corresponding to the purged content is added to Recently Purged Pages (RPP) list 606. Subsequent transfer of content to non-persistent cache 626 causes cache control 604 to first compare the URL of the transferred content to any URLs that may exist within RPP 606. If such an entry exists, then cache control 604 determines that the URL being cached has previously been purged, which causes purge count 608 to be incremented by cache control 604.

Once purge count 608 reaches a pre-determined value, cache control 604 displays message 624 to the display of browsing terminal 602. Message 624 indicates to the user of mobile terminal 602 that a recognized pattern of received content versus purged content has been detected. In particular, the number of instances that the same URL has been cached and subsequently purged equals a pre-configured threshold, which constitutes a realization by cache control 604 that the URL is popular. Accordingly, an opportunity is provided by a smart persistence feature within cache control 604 to allow the user of browsing terminal 402 to change the priority directive of the popular URL from non-persistent to persistent.

In order to aid the decision to be made by the user, the amount of memory needed to cache the popular content is provided to the user as “X KB NEEDED” within message 624. In addition, the amount of memory available within persistent cache (not shown) is provided as “Y KB AVAILABLE”. The user may elect to store the popular content to persistent cache, in which case cache control 604 transfers content 628 to persistent cache. Otherwise, if the user of browsing terminal 602 does not wish to make the popular content persistent, then cache control 604 does nothing to content 628, and adds the URL of content 628 to NO-OP 630 so that cache control 604 will not ask the user about content 628 in the future. Thus, content 628 remains under the normal LRU cache control algorithm and will be purged once it is the least recently used item in the non-persistent cache and the cache needs to free some space for new content.

RPP 606 may also be monitored by the normal LRU cache control algorithm to avoid an over sized RPP list. In such an instance, entries within RPP 606 may be time tagged each time they match up with a received URL. If the difference between the current time and the time tag portion of any entry within RPP 606 exceeds a pre-determined threshold, then the LRU cache control algorithm may determine that the particular RPP entry has aged past an allowable time limit and be subsequently purged from RPP 608.

In an alternate embodiment according to the present invention, automatic determination of the priority directive for received content may be executed by cache control 604 when origin server 614 does not send priority directives with the content. In such an instance, cache control 604 identifies the received content as coming from the service provider's home page URL directory or subordinate directories. Cache control 604 then compares the URL of the received content to a stored service provider home page URL directory. If the received content is from the home page URL directory, or subordinate directories, then cache control 604 automatically assigns a priority directive based on the level of the Web page in the service provider's URL directory tree. In the case where the content is an associated image, style sheet, or other file, the priority directive that is assigned by cache control 604 inherits the priority of the Web page that includes the associated image, style sheet, or other file.

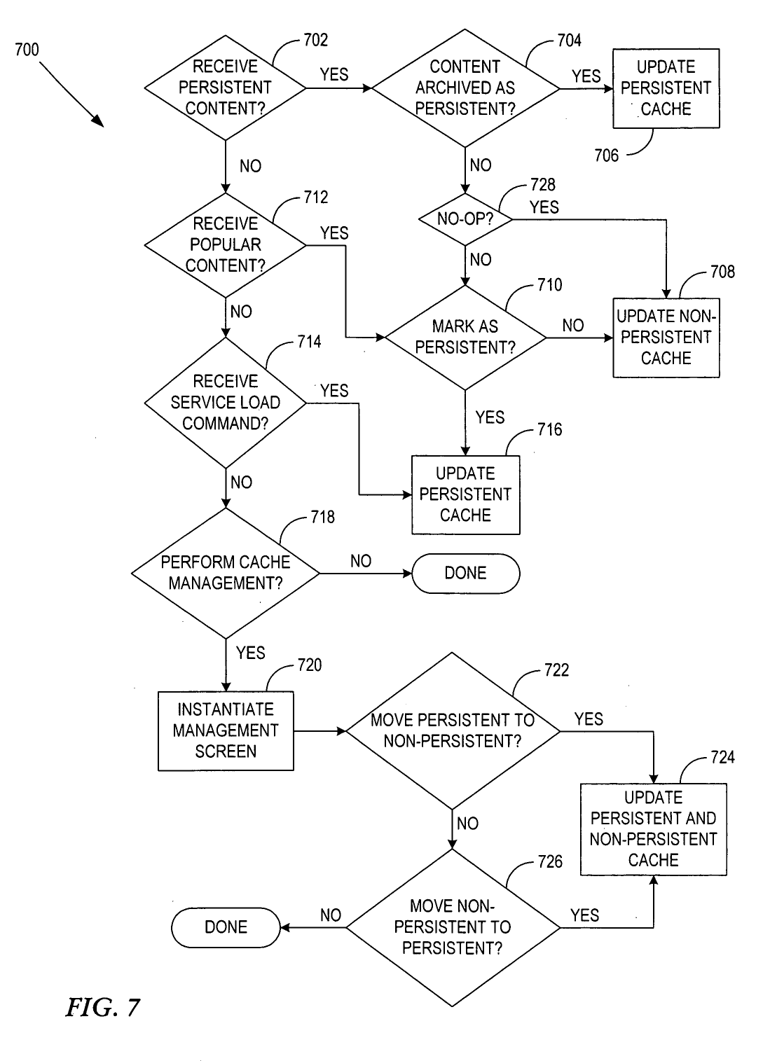

Flow diagram 700 of FIG. 7 illustrates an exemplary method in which smart, persistent cache interacts with a user's browsing session or cache management session in accordance with the present invention. In step 702, the user may be in a cache management session or a browsing session. If the YES path of step 702 is taken, then the user is in a browsing session and content is received by browsing terminal, e.g., 402 of FIG. 4. The content, e.g., 420, is then examined by cache control 404 for cache control directive, e.g., 416, which designates whether the received content was made persistent by the content provider, e.g., origin server 414.

In step 704, cache control 404 determines whether the received content 420 was previously saved into persistent cache, e.g., 406. If not, then the NO path of step 704 is taken, whereby cache control 404 checks NO-OP list 432 in step 728 to see if content 420 is listed as “non-persistent”. If so, the user has previously rejected making content 420 persistent, so it is updated to non-persistent cache as in step 708. If the content is not listed in NO-OP list 432, then cache control 404 displays a message, e.g., 424, to the user of browsing terminal 402 as in step 710. Message 424 provides an opportunity for the user to override the priority directive of content 420. In such an instance, users are protected from malicious content providers wishing to lodge content within the persistent cache of their associated browsing terminals. If the user wishes to make the content persistent, then the YES path of step 710 is taken, whereby the content is stored in step 716 within persistent cache 406 as content, e.g., 408. Otherwise, the NO path is taken from step 710, whereby the content is saved in step 708 as content, e.g., 428, in non-persistent cache, e.g., 426, and NO-OP list 432 is updated with the URL of content 420. If, on the other hand, the content received has been previously saved within persistent cache 406, then the previously saved content is updated in step 706 with the newly received content.

If the user is currently active in a browsing session and has received content not marked as persistent, then the NO path of step 702 is taken. The content received is then examined by cache control, e.g., 604, before saving to non-persistent cache, e.g., 626 to determine its previously purged status. Cache control 604 may determine that the content received has been previously purged, for example, by examining RPP 606 for any URLs that correspond to the URL associated with the received content. If cache control 604 has determined that the content received has been previously purged, e.g., previous content saved in non-persistent cache 626 has exceeded the age limit imposed by the “max-age” directive or the Expires header, then purge count, e.g., 608, is incremented.

Cache control 604 then compares the new purge count with a pre-determined threshold. If the purge count exceeds the pre-determined threshold, then cache control 604 determines that the received content may be classified as being popular. In such an instance, cache control 604 then displays message, e.g., 624, in step 710 to allow the user the opportunity to save the content into persistent cache, so that future viewing of the popular content may be expedited through the use of local memory. If the user declines to make the content persistent, then the NO path of step 710 is taken and the content is stored into non-persistent cache 626 as content, e.g., 628. Otherwise, the YES path of step 710 is taken and the popular content is then added to persistent cache as in step 716.

Step 714 allows a mechanism whereby a content originator, e.g., origin server 314, may force a refresh operation upon content, e.g., 308, contained in persistent cache, e.g., 306. In one embodiment, a CO command may be received via message 326, whereby the URI of content 308 is contained within the CO command of message 326. Upon receipt, cache control 304 invalidates the cached copy of content 308. In so doing, cache control 304, in response to CO message 326, forces an update on content 308 when a subsequent access of the URL associated with content 308 has been commanded by the user of mobile terminal 302. Once the user accesses the URL, content 308 is updated in step 716 by the corresponding content contained within origin server 314 prior to being displayed to the user of mobile terminal 302. In another embodiment, an SL command with action=“cache” causes the browser to request the content from the URL over the network, through silent execution in the background. The browser then processes the content according to the normal cache rules and method according to the present invention, thus replacing any copy of it that may already be present in the cache.

Cache management operations are allowed by step 718, such that a cache management screen, e.g., 504, is instantiated to allow the user of mobile terminal 502 to control the contents of persistent cache, e.g., 506, and non-persistent cache, e.g., 508. If the user of mobile terminal 502 wishes to move contents of persistent cache 506 to non-persistent cache 508, then the YES path of step 722 is taken. In such an instance, persistent cache, e.g., 512, is left with one entry, whereas non-persistent cache, e.g., 514, increases by one entry. Conversely, the user may wish to move contents of non-persistent cache into persistent cache as in step 726. If so, then both cache 506 and 508 are updated as in step 724.

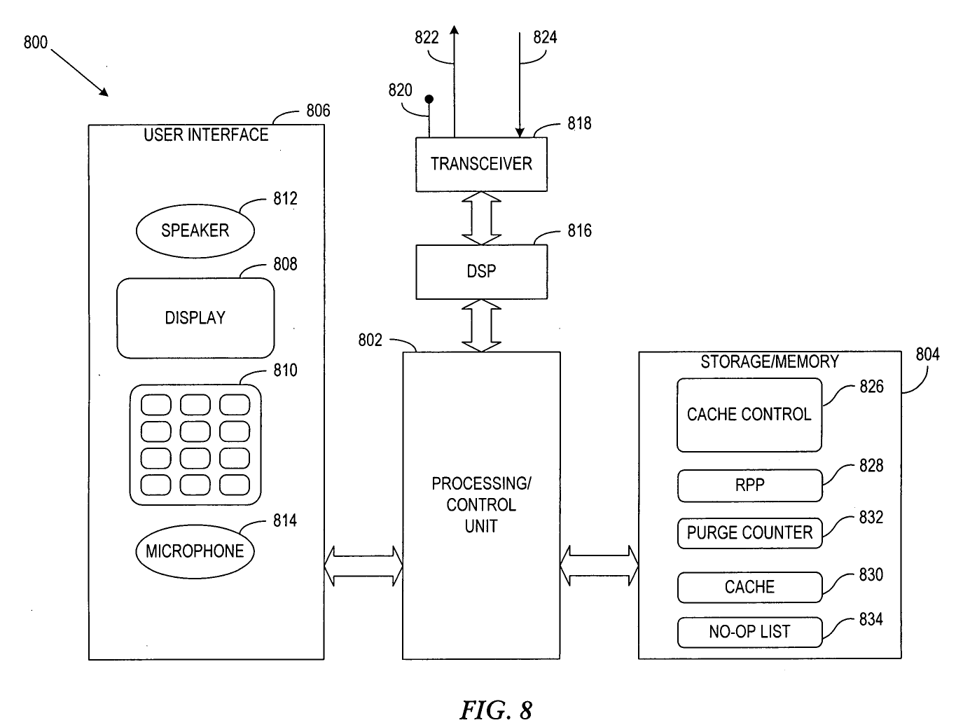

The invention is a modular invention, whereby processing functions within either a mobile terminal or a hardware platform may be utilized to implement the present invention. The mobile terminals may be any type of wireless device, such as wireless/cellular telephones, personal digital assistants (PDAs), or other wireless handsets, as well as portable computing devices capable of wireless communication. These landline and mobile devices utilize computing circuitry and software to control and manage the conventional device activity as well as the functionality provided by the present invention. Hardware, firmware, software or a combination thereof may be used to perform the various cache management functions described herein. An example of a representative mobile terminal computing system capable of carrying out operations in accordance with the invention is illustrated in FIG. 8. Those skilled in the art will appreciate that the exemplary mobile computing environment 800 is merely representative of general functions that may be associated with such mobile devices, and also that landline computing systems similarly include computing circuitry to perform such operations.

The exemplary mobile computing arrangement 800 suitable for cache management functions in accordance with the present invention may be associated with a number of different types of wireless devices. The representative mobile computing arrangement 800 includes a processing/control unit 802, such as a microprocessor, reduced instruction set computer (RISC), or other central processing module. The processing unit 802 need not be a single device, and may include one or more processors. For example, the processing unit may include a master processor and associated slave processors coupled to communicate with the master processor.

The processing unit 802 controls the basic functions of the mobile terminal, and also those functions associated with the present invention as dictated by cache control 826, RPP 828, purge counter 832, cache 830, and NO-OP list 834 available in the program storage/memory 804. Thus, the processing unit 802 is capable of performing persistent and non-persistent cache operations on cache 830 in response to: Web browsing sessions; management sessions; or by smart persistent operations performed by cache control 826 in combination with RPP 828 and purge counter 832. The program storage/memory 804 may also include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc.

In one embodiment of the invention, the program modules associated with the storage/memory 804 are stored in non-volatile electrically-erasable, programmable ROM (EEPROM), flash ROM, etc. so that the information is not lost upon power down of the mobile terminal. The relevant software for carrying out conventional mobile terminal operations and operations in accordance with the present invention may also be transmitted to the mobile computing arrangement 800 via data signals, such as being downloaded electronically via one or more networks, such as the Internet and an intermediate wireless network(s).

The processor 802 is also coupled to user-interface 806 elements associated with the mobile terminal. The user-interface 806 of the mobile terminal may include, for example, a display 808 such as a liquid crystal display, a keypad 810, speaker 812, and microphone 814. These and other user-interface components are coupled to the processor 802 as is known in the art. Other user-interface mechanisms may be employed, such as voice commands, switches, touch pad/screen, graphical user interface using a pointing device, trackball, joystick, or any other user interface mechanism.

The mobile computing arrangement 800 also includes conventional circuitry for performing wireless transmissions. A digital signal processor (DSP) 816 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 818, generally coupled to an antenna 820, transmits the outgoing radio signals 822 and receives the incoming radio signals 824 associated with the wireless device.

The mobile computing arrangement 800 of FIG. 8 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a cache management system and method in accordance with the present invention.

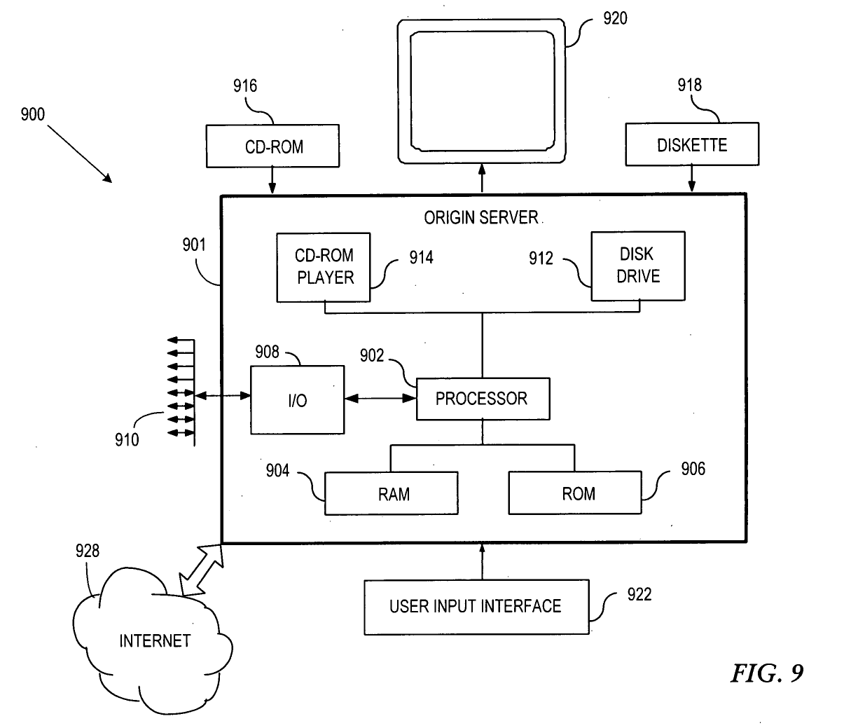

The origin servers or other systems for providing server functions in connection with the present invention may be any type of computing device capable of processing and communicating digital information. The origin server platforms utilize computing systems to control and manage the markup modification activity. An example of a representative computing system capable of carrying out operations in accordance with the invention is illustrated in FIG. 9. Hardware, firmware, software or a combination thereof may be used to perform the various Web content functions and operations described herein. The computing structure 900 of FIG. 9 is an example computing structure that can be used in connection with such a Web content platform.

The example computing arrangement 900 suitable for performing the content hosting activity in accordance with the present invention includes origin server 901, which includes a central processor (CPU) 902 coupled to random access memory (RAM) 904 and read-only memory (ROM) 906. The ROM 906 may also be other types of storage media to store programs, such as programmable ROM (PROM), erasable PROM (EPROM), etc. The processor 902 may communicate with other internal and external components through input/output (I/O) circuitry 908 and bussing 910, to provide control signals and the like. For example, data received from I/O connections 908 or Internet connection 928 may be processed in accordance with the present invention. External data storage devices, such as PPGs, may be coupled to I/O circuitry 908 to facilitate content hosting functions according to the present invention. Alternatively, such databases may be locally stored in the storage/memory of origin server 901, or otherwise accessible via a local network or networks having a more extensive reach such as the Internet 928. The processor 902 carries out a variety of functions as is known in the art, as dictated by software and/or firmware instructions.

Origin server 901 may also include one or more data storage devices, including hard and floppy disk drives 912, CD-ROM drives 914, and other hardware capable of reading and/or storing information such as DVD, etc. In one embodiment, software for carrying out the content hosting operations in accordance with the present invention may be stored and distributed on a CD-ROM 916, diskette 918 or other form of media capable of portably storing information. These storage media may be inserted into, and read by, devices such as the CD-ROM drive 914, the disk drive 912, etc. The software may also be transmitted to origin server 901 via data signals, such as being downloaded electronically via a network, such as the Internet. Origin server 901 is coupled to a display 920, which may be any type of known display or presentation screen, such as LCD displays, plasma display, cathode ray tubes (CRT), etc. A user input interface 922 is provided, including one or more user interface mechanisms such as a mouse, keyboard, microphone, touch pad, touch screen, voice-recognition system, etc.

Origin server 901 may be coupled to other computing devices, such as the landline and/or wireless terminals via a network. The server may be part of a larger network configuration as in a global area network (GAN) such as the Internet 928, which allows ultimate connection to the various landline and/or mobile client/watcher devices.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

What is claimed is:

1. A network browsing system, comprising:
a network having Web pages addressable by Uniform Resource Locators (URLs);
a terminal coupled to the network to receive content associated with the Web pages, the terminal including:
a cache controller adapted to determine cache attributes of the received content; and
a cache memory coupled to the cache controller to store the content in a location indicated by the cache attributes.

2. The network browsing system according to claim 1, wherein the cache memory comprises:
a persistent cache memory adapted to store persistent content; and
a non-persistent cache memory adapted to store non-persistent content, wherein the cache controller determines which cache memory the content is to be stored by inspecting a cache persistence directive associated with the cache attributes.

3. The network browsing system according to claim 2, wherein the terminal further comprises:
a purge list adapted to maintain entries corresponding to URLs previously purged by the cache controller; and
a purge counter adapted to maintain a count indicating a number of instances that the purged content corresponds to an older version of the received content.

4. The network browsing system according to claim 1, wherein the terminal further comprises a display adapted to provide an indication of the cache attributes associated with the received content.

5. The network browsing system according to claim 4, wherein the display facilitates an override of the storage location determined by the cache controller.

6. The network browsing system according to claim 1, further comprising an origin server adapted to modify the cache attributes of the stored content.

7. A method for managing content received by a terminal from a network, comprising:
inspecting a priority directive associated with the received content;
allowing a modification to be made on the priority directive of the received content; and
storing the received content in a storage location indicative of the priority directive.

8. The method according to claim 7, wherein inspecting the priority directive comprises:
comparing the received content with content previously received; and
updating a storage location of the previously received content if the received content is associated with the previously received content.

9. The method according to claim 8, wherein allowing a modification to be made on the priority directive of the received content comprises allowing an alternative storage location to be selected if the storage location of the previously received content is different than the storage location indicated by the priority directive of the received content.

10. The method according to claim 9, wherein the alternative storage location is selected by modifying the priority directive to be indicative of the desired alternative storage location.

11. The method according to claim 10, wherein storing the received content comprises:
directing the received content to persistent storage if the priority directive indicates use of persistent storage; and
directing the received content to non-persistent storage if the priority directive indicates use of non-persistent storage.

12. The method according to claim 7, wherein allowing a modification to be made on the priority directive of the received content comprises:
displaying a plurality of lists, each list containing entries indicative of received content storage locations; and
modifying a priority directive associated with each entry.

13. The method according to claim 7, further comprising:
detecting stale content in non-persistent storage; and
purging the stale content.

14. The method according to claim 13, further comprising:
comparing the purged content to the received content; and
incrementing a purge count if the purged content is related to the received content.

15. The method according to claim 14, wherein the modification of the priority directive is allowed in response to determining that the incremented purge count exceeds a predetermined threshold.

16. An origin server coupled to a network to provide priority directives within requested content hosted by the origin server, the origin server comprising:
means for receiving a content request from a browsing terminal;
means for generating content in response to the content requests;
means for adding priority directives to header information associated with the requested content; and
means for sending a response to the browsing terminal containing the header information and the requested content, wherein the priority directives indicate a storage location to be used by the browsing terminal.

17. The server according to claim 16, further comprising means to modify age characteristics of requested content in the storage location of the browsing terminal.

18. A computer-readable medium having instructions stored thereon which are executable by an origin server by performing steps comprising:
receiving a content request from a browsing terminal;
generating content in response to the content request; and
adding priority directives to header information associated with the requested content.

19. The computer-readable medium according to claim 18, further comprising steps to modify age characteristics of requested content in the storage location of the browsing terminal.

20. A mobile terminal capable of being wirelessly coupled to a network to receive content hosted by a content provider within the network, the mobile terminal comprising:
a memory capable of storing at least one of a cache control module and a cache memory module;
a processor coupled to the memory and configured by the cache control module to direct the received content into portions of the cache memory module; and
a transceiver configured to facilitate the content exchange, wherein the cache control module is responsive to cache and priority directives supplied by the content provider in determining which portion of the cache memory module to use for storage.

21. The mobile terminal according to claim 20, wherein the cache memory module comprises:
a persistent storage location adapted to receive persistent content; and
a non-persistent storage location adapted to receive non-persistent content.

22. The mobile terminal according to claim 21, wherein the memory further comprises a purge list adapted to provide a history of content purged from the non-persistent storage location.

23. The mobile terminal according to claim 22, wherein the memory further comprises a purge counter adapted to provide a count indicative of the number of instances that the purged content corresponds to an aged version of the received content.

24. A computer-readable medium having instructions stored thereon which are executable by a mobile terminal for providing a smart persistent cache by performing steps comprising:
storing received content into one of a persistent cache storage location and a normal cache storage location in response to a priority directive associated with the received content;
conditionally purging content from the persistent cache storage location to provide storage for high priority received content, the high priority received content having a priority directive indicative of the persistent cache storage location; and
diverting the high priority received content to the normal cache storage location when purging content from the persistent cache storage location is not allowed.

25. The computer readable medium of claim 24, wherein conditionally purging content from the persistent cache storage location comprises purging content having a lower priority than the received content when the persistent cache storage location is full.

26. The computer readable medium of claim 25, wherein conditionally purging content from the persistent cache storage location further comprises purging least recently used content when there is no lower priority content contained within the persistent cache storage location relative to the received content.

27. The computer readable medium of claim 26, wherein the purged content is diverted to the normal cache storage location.

28. A method of determining a storage location for received content, comprising:
comparing the received content to previously purged content;
incrementing a purge count if the received content matches a Uniform Resource Locator (URL) of the previously purged content;
comparing the purge count to a predetermined threshold;
automatically assigning a priority directive and allowing storage of the received content into a persistent cache if the purge count exceeds the predetermined threshold; and
storing the received content into a normal cache if the purge count does not exceed the predetermined threshold.

29. A method of automatically determining a priority directive of received content, the method comprising:.
detecting an absence of a priority directive within the received content;
comparing a Uniform Resource Locator (URL) associated with the received content to a previously stored service provider's URL directory tree; and
assigning a priority directive to the received content in response to finding a match between the URL associated with the received content and the previously stored service provider's URL directory tree, wherein the assigned priority directive is indicative of a position of the matched URL in the service provider's URL directory tree.

30. A method of automatically determining a priority directive of received content, the method comprising:
comparing a Uniform Resource Locator (URL) associated with the received content to a list of frequently accessed URLs; and
assigning a priority directive to the received content in response to finding a match between the URL associated with the received content and the list of frequently accessed URLs, wherein the assigned priority directive is indicative of a frequency of use of the matched URL.
